(19) United States
(12) Patent Application Publication
(10) Pub. No.: US 2024/0269037 A1
(43) Pub. Date: Aug. 15, 2024

(54) Ultrasonic massage instrument

(71) Applicant: Zhijun PENG, Foshan (CN)

(72) Inventor: Zhijun PENG, Foshan (CN)

(21) Appl. No.: 18/200,563

(22) Filed: May 22, 2023

(30) Foreign Application Priority Data
Feb. 13, 2023 (CN) 2023101058795

(51) Int. Cl. A61H 23/02

(52) U.S. Cl. CPC A61H 23/0245; A61H 2201/0107; A61H 2201/1695; A61H 2201/5025

(57) ABSTRACT

An ultrasonic massage instrument, having at least one ultrasonic massage device; two lateral sides of each ultrasonic massage device are respectively provided with a soft connecting belt and a hard connecting piece with a through hole; a free end of the soft connecting belt passes through the through hole of the hard connecting piece and is folded and fixed on the soft connecting belt, such that a working cavity is formed between the soft connecting belt and surfaces of the ultrasonic massage device facing to the soft connecting belt to accommodate a human body part. Users may chain up multiple ultrasonic massage devices to form multiple massage positions, hence body massage may be synchronically applied to various body parts which is more effective and more efficient. A single ultrasonic massage device may be tied to each of the different body parts to provide synchronic massage, thereby achieving various flexible combinations.

### FIELD OF THE INVENTION

This invention relates to the field of human body therapeutic massage instruments, in particular to an ultrasonic massage instrument which may be tied on the waist, arms, legs, neck, head or other parts of the human body and provides massage.

### BACKGROUND OF THE INVENTION

As human society develops, people live a fast-paced life, often work overtime, stay up late and maintain a certain posture for a long time, which affect the blood circulation of the waist, arms, legs, neck, head and other body parts and will cause symptoms such as soreness, pain, and stiffness. People may be affected by sub-health over time.

In order to solve the problem of sub-health, the Applicant submitted a patent (CN210355321U) to the China National Intellectual Property Administration on 17 Jan. 2019 which discloses an airbag-type ultrasonic therapeutic massage bandage”. This solution adopts ultrasonic components to generate high-frequency ultrasonic vibration and apply to parts of the human body in discomfort, such that the vibration energy is applied to human muscles to activate muscle cells and facilitate blood circulation, thereby relieving soreness, pain, stiffness and other discomfort symptoms. A long-term usage helps solve the problem of sub-health and strengthen the body.

Although the aforementioned solution helps solve the problem of sub-health, the invention still has the following deficiencies in practical application: the invention comprises a flat strap body, a flat airbag body, an ultrasonic transducer, massage bumps and a control host, such that the area of high-frequency vibration only covers one body part each time and the invention does not have expansion sets or combinations to satisfy the need of users, which is inflexible. The airbag structure also leads to a larger size of the device. Both the airbag and the ultrasonic transducer consume energy and thus leading to higher power consumption of the entire device such that the device may only be powered by AC but not storage battery. The large size and the limitation of power supply source make hand-carriage impossible. The Applicant believes that the device should be improved to better fit the need of therapeutic massage of people in daily life.

### BRIEF SUMMARY OF THE INVENTION

To solve the aforementioned problems, the present invention provides an ultrasonic massage instrument which comprises at least one ultrasonic massage device each having a soft connecting belt and a hard connecting piece; the structure of the present invention is simple and the size is small enough to be carried; storage battery may be used to supply electricity and the power consumption is low; users may chain up multiple ultrasonic massage devices to form multiple massage positions which can be operated synchronously, hence a body massage may be synchronically applied to various body parts which is more effective and more efficient. A single ultrasonic massage device may also be tied to each of different body parts to provide synchronic massage; the ultrasonic massage instrument allows various combinations and hence is flexible.

The technical solution is as follows: An ultrasonic massage instrument, comprising at least one ultrasonic massage device; two lateral sides of each ultrasonic massage device are respectively provided with a soft connecting belt and a hard connecting piece with a through hole; when said at least one ultrasonic massage device comprises only one ultrasonic massage device, a free end of the soft connecting belt passes through the through hole of the hard connecting piece and is folded and fixed on the soft connecting belt, such that a working cavity is formed between the soft connecting belt and surfaces of the ultrasonic massage device facing to the soft connecting belt to accommodate a human body part.

Further, when said at least one ultrasonic massage device comprises a plurality of ultrasonic massage devices, the soft connecting belt of any one of the ultrasonic massage devices is connected to the hard connecting piece of another adjacent ultrasonic massage device to form an ultrasonic massage main body in a shape of an annular chain; the working cavity is enclosed by an inner side of the ultrasonic massage main body.

Further, an outer protruding part with a slot is provided on each ultrasonic massage device; a lock hole is provided on the outer protruding part; an end of the soft connecting belt fitted with the outer protruding part is provided with a plug in cooperation with the slot; a snap pin in cooperation with the lock hole is provided on the plug.

Further, the present invention also comprises a charging storage box, which comprises a cover and a base; the base is provided with at least one first cavity slot where said at least one ultrasonic massage device is stored; a micro storage battery is provided in each ultrasonic massage device; charging interfaces are provided between each first cavity slot and a corresponding ultrasonic massage device.

Further, the present invention also comprises a controller to operate and control said at least one ultrasonic massage device; the controller has a micro storage battery; the charging storage box is also provided with a second cavity slot to accommodate the controller; charging interfaces are also provided between the second cavity slot and the controller; the controller is connected to said at least one ultrasonic massage device through wireless communication modules.

The benefits of the present invention are: The present invention provides an ultrasonic massage instrument which comprises at least one ultrasonic massage device each having a soft connecting belt and a hard connecting piece; the structure of the present invention is simple and the size is small enough to be carried; storage battery may be used to supply electricity and the power consumption is low; users may chain up multiple ultrasonic massage devices to form multiple massage positions which can be operated synchronously, hence a body massage may be synchronically applied to various body parts which is more effective and more efficient. A single ultrasonic massage device may also be tied to each of different body parts to provide synchronic massage; the ultrasonic massage instrument allows various combinations and hence is flexible. The present invention also applies high-frequency ultrasonic vibration to parts of the human muscles, such that the vibration energy is applied to human muscles to facilitate blood circulation and relieve muscle fatigue. The present invention does not produce much noise during operation and does not cause muscle pain, thereby providing comfortable massaging experience. The present invention facilitates blood circulation, blood cavitation, and promotes metabolism and hence helps maintain health.

### BRIEF DESCRIPTION OF THE DRAWINGS

FIG. 1 shows a structural view of an embodiment of the present invention adopting a single ultrasonic massage device;

FIG. 2 shows a structural view of another embodiment of the present invention adopting two ultrasonic massage devices;

FIG. 3 shows a structural view of a third embodiment of the present invention adopting multiple ultrasonic massage devices;

FIG. 4 shows an exploded view of an ultrasonic massage device of the present invention;

FIG. 5 shows a cross-sectional view of an ultrasonic massage device of the present invention;

FIG. 6 shows a perspective view of the charging storage box;

FIG. 7 shows a cross-sectional view of the base of the charging storage box of the present invention;

FIG. 8 shows a schematic view of the present invention when being used on a human body.

### DETAILED DESCRIPTION OF THE INVENTION

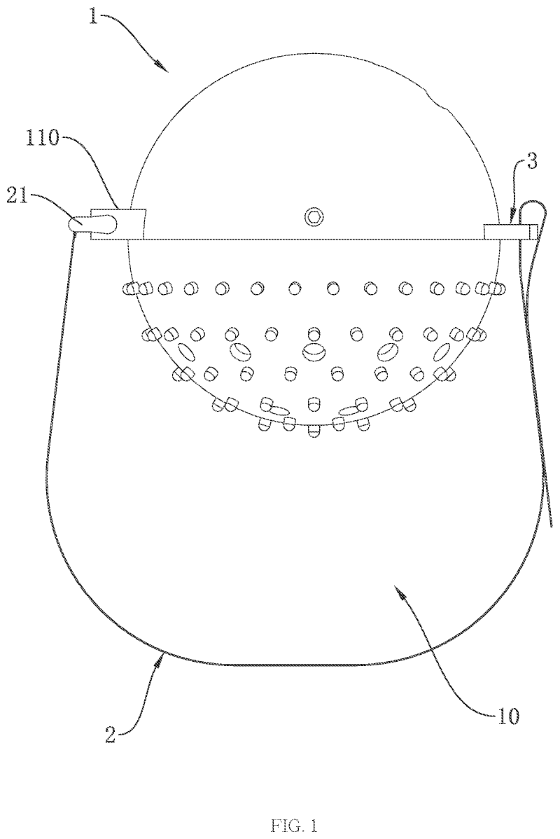

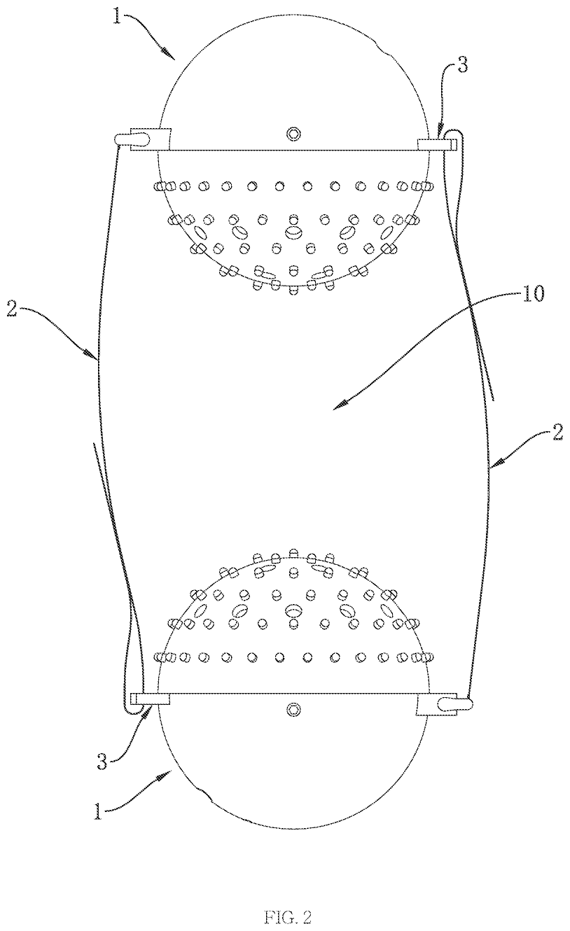

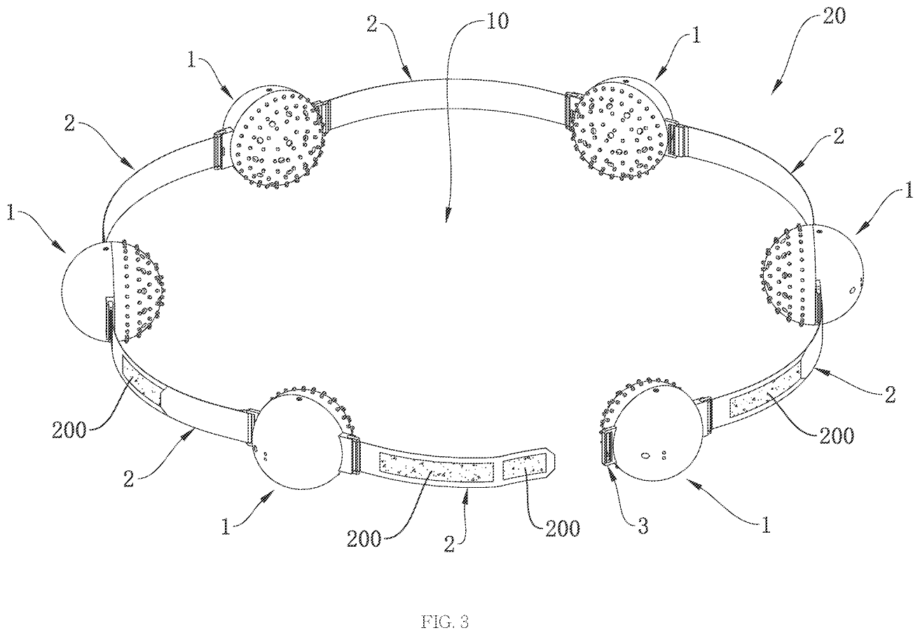

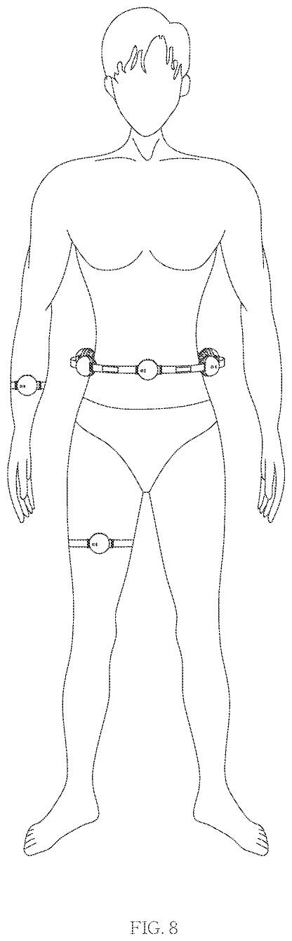

As shown in FIG. 1 to FIG. 3, an ultrasonic massage instrument, comprises at least one ultrasonic massage device 1; two lateral sides of each ultrasonic massage device 1 are respectively provided with a soft connecting belt 2 and a hard connecting piece 3 with a through hole 31; in an embodiment where only one ultrasonic massage device 1 is provided, a free end of the soft connecting belt 2 passes through the through hole 31 of the hard connecting piece 3 and is folded and fixed on the soft connecting belt 2, such that a working cavity 10 is formed between the soft connecting belt 2 and surfaces of the ultrasonic massage device 1 facing to the soft connecting belt 2 to accommodate a human body part. The above scheme allows the present invention to be combined flexibly and freely according to needs in actual use, and various usage modes may be adopted. As shown in FIG. 1, the present invention may provide only a single ultrasonic massage device 1; as shown in FIG. 2, the present invention may be a combination of two ultrasonic massage devices 1; as shown in FIG. 3, three or more ultrasonic massage devices 1 may be used together. When using two or more ultrasonic massage devices 1, FIG. 3 can be referred to, wherein the soft connecting belt 2 of any one of the ultrasonic massage devices 1 is connected to the hard connecting piece 3 of another adjacent ultrasonic massage device to form an ultrasonic massage main body 20 in a shape of an annular chain; an inner side of the ultrasonic massage main body 20 forms the working cavity 10 to accommodate human body parts. As shown in FIG. 8, only one of said ultrasonic massage device 1 or combinations of different quantities of more than one of said ultrasonic massage devices 1 may be applied to different parts of the human body for ultrasonic massage, for example, to be tied on arms, thighs, waist, etc.

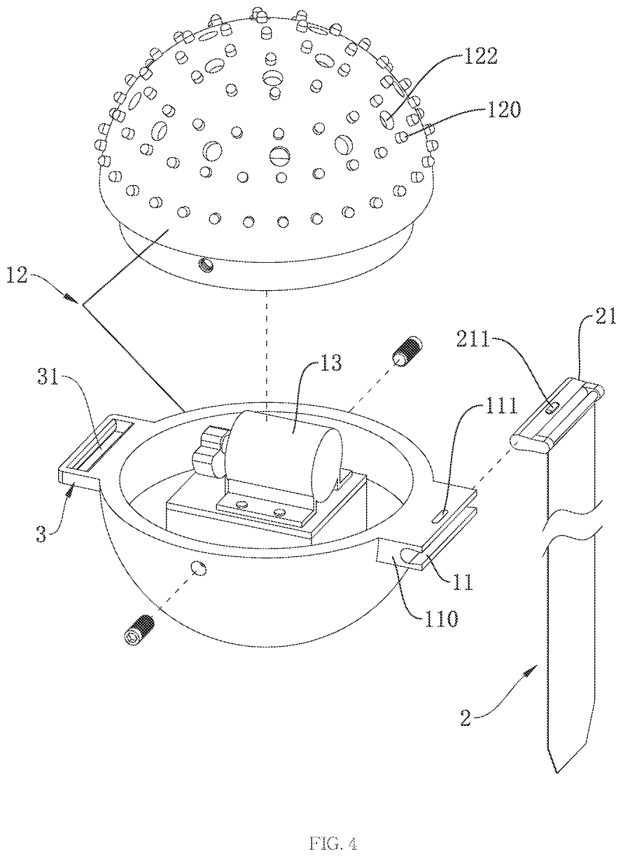

Since the sizes and dimensions of body parts between different users are different, users may need to choose different soft connection belts of different specifications for installation and use according to the sizes and dimensions of their body parts; for the ease of installing different soft connection belts, as shown in FIG. 4, an outer protruding part 110 with a slot 11 is provided on each ultrasonic massage device 1; a lock hole 111 is provided on the outer protruding part 110; an end of the soft connecting belt 2 to be fitted with the outer protruding part is provided with a plug 21 in cooperation with the slot 11; an snap pin 211 in cooperation with the lock hole 111 is provided on the plug 21. When the plug 21 is inserted into the slot 11, the snap pin 211 on the plug 21 is snapped in the lock hole 111 via a built-in return spring of the snap pin 211, so that the soft connection belt 2 is installed and fixed with the outer protruding part 110. To unlock and dismount, the snap pin 211 is pressed down by hand or a hand tool, and the plug 21 is withdrawn from the slot 11. Therefore, it is convenient to install different soft connection belts 2 of different specifications, and the soft connection belt 2 may be easily disassembled and washed to maintain cleanliness. The soft connection belt 2 may be made of leather, soft rubber or cloth. A surface of the soft connection belt 2 is provided with a hook-and-loop fastener 200, so that the free end of the soft connecting belt 2 passing the through hole 31 of the hard connecting piece 3 can be folded and fixed on the soft connection belt 2, as shown in FIG. 1 or FIG. 2. The hook-and-loop fastener 200 may be replaced by a magnetic sheet embedded inside the soft connecting belt 2.

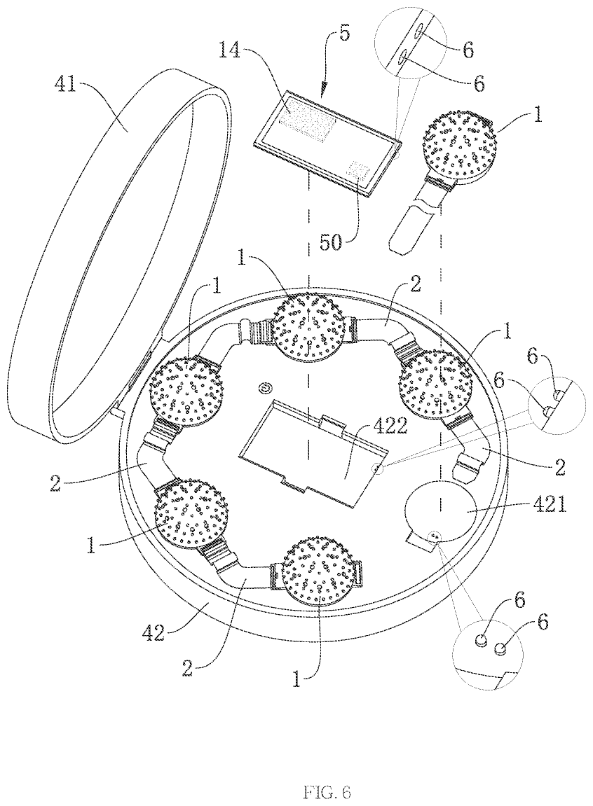

To collect, charge and store all the ultrasonic massage devices 1 together, as shown in FIG. 6, the present invention comprises a charging storage box 4, which comprises a cover 41 and a base 42; the base 42 is provided with first cavity slots 421 where the ultrasonic massage devices 1 are stored; a micro storage battery 14 is provided in each ultrasonic massage device 1; charging interfaces 6 are provided between each first cavity slot 421 and a corresponding ultrasonic massage device 1. This design provides easy storage and charging of a plurality of ultrasonic massage devices, making the present invention easier and more convenient to use. The charging interfaces 6 between each first cavity slot 421 and the corresponding ultrasonic massage device 1 may be formed by wireless charging transmitting coils arranged inside each first cavity groove 421 and wireless charging receiving coils arranged inside the corresponding ultrasonic massage device 1 to realize wireless radio frequency charging. As shown in FIG. 6, the charging interfaces 6 between each first cavity slot 421 and the corresponding ultrasonic massage device 1 may also be formed by a pair of charging contacts in the first cavity slot 421 and another pair of corresponding charging contacts on a side of the ultrasonic massage device 1 to realize charging by charging contacts.

In order to facilitate unified operation and control of all ultrasonic massage devices 1, as shown in FIG. 6, the present invention also comprises a controller 5 to operate and control the ultrasonic massage devices 1; the controller 5 has a micro storage battery 14; the charging storage box 4 is also provided with a second cavity slot 422 to accommodate the controller 5; charging interfaces 6 are also provided between the second cavity slot 422 and the controller 5; the controller 5 is connected to the ultrasonic massage devices 1 through wireless communication modules 50. The wireless communication modules 50 may be Bluetooth® communication modules or WIFI communication modules respectively installed in the controller 5 and each of the ultrasonic massage devices 1. The controller 5 may be a touch screen controller with a full-screen design, or a controller with button operation, or a controller combining a display screen and buttons. The controller 5 generally comprises a case, a circuit board installed inside the case, the micro storage battery 14 installed inside the case, and a respective wireless communication module 50 installed inside the case etc. The charging interfaces 6 between the second cavity slot 422 and the controller 5 may be formed by wireless charging transmitting coils provided inside the second cavity slot 422 and wireless charging receiving coils provided inside the controller 5 to realize wireless radio frequency charging. As shown in FIG. 6, the charging interfaces 6 between the second cavity slot 422 and the controller 5 may also be formed by a pair of charging contacts in the second cavity slot 422 and another pair of corresponding charging contacts on a side of the controller 5 to realize charging by charging contacts. The second cavity slot 422 may be provided on a surface of the cover 41 (which is not shown in the figures) or provided inside the base 42 as shown in FIG. 6.

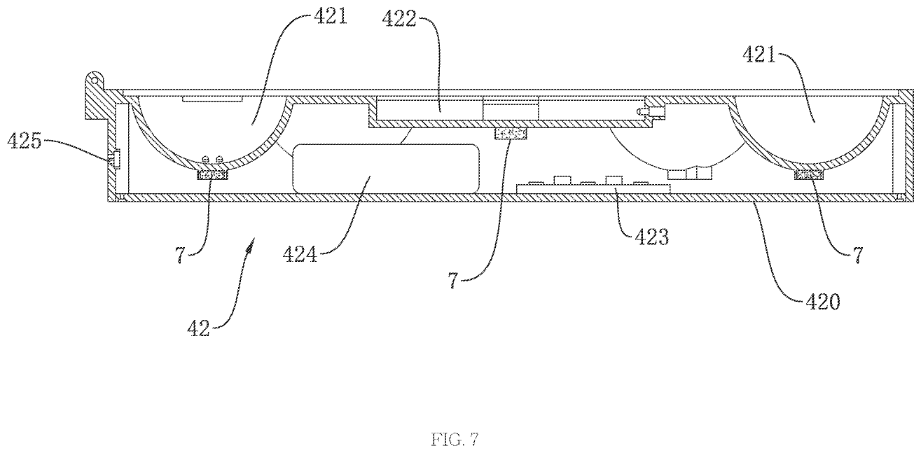

As shown in FIG. 7, the base 42 comprises a base case 420, a charging circuit board 423, a storage battery 424, and a power interface 425; the charging circuit board 423 and the storage battery 424 are installed in the base case 420, and the power interface 425 is installed on a lateral side of the base case 420. When each ultrasonic massage device 1 and the controller 5 are put back into the charging storage box 4, the storage battery 424 inside the base 42 automatically charges each ultrasonic massage device 1 and the controller 5. The power interface 425 is a charging interface for the storage battery 424 provided in the base 42, and is connected to a home grid through wires.

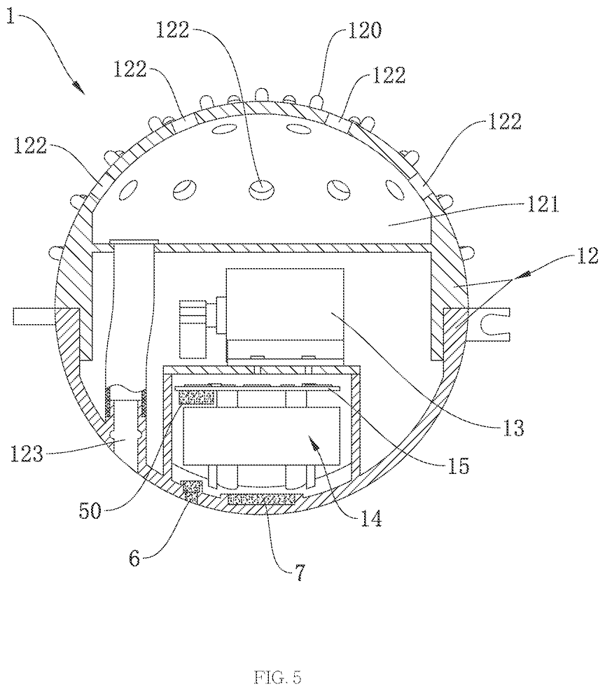

As shown in FIG. 4 and FIG. 5, each ultrasonic massage device 1 comprises a case 12, an ultrasonic vibrating element 13, a micro storage battery 14, and a micro working circuit board 15; one side of the case 12 is provided with a plurality of evenly distributed massage bumps 120, and another side of the case 12 is provided with the charging interfaces 6; the ultrasonic vibrating element 13, the micro storage battery 14, and the micro working circuit board 15 are installed in the case 12. As shown in FIG. 1 to FIG. 3, when using, the side of the case provided with the massage bumps 120 is placed towards the working cavity 10.

To provide more functions, as shown in FIG. 4 and FIG. 5, a sealed inner cavity 121 is provided in an interior of the case 12 proximal to the side of the case 12 provided with the massage bumps 120; gaps are formed between the massage bumps 120; spray holes 122 in communication with the sealed inner cavity 121 are provided on the gaps; a tube port 123 in communication with the sealed inner cavity 121 is provided on said another side of the case 12. The tube port 123 is configured to be connected to a medicine-supplying apparatus through a pipeline, which details are available to a skilled person in the art in prior patent document CN211723956U titled “A centralized medicine-supplying ultrasonic massage device”, wherein a medicine-supplying instrument atomizes liquid medicine to mist droplets which is then pumped and delivered through a sealed inner cavity, and the medicine-supplying instrument may provide massage and apply atomized medicine to human muscles synchronically, thereby enhancing the therapeutic effect.

To ensure each ultrasonic massage device 1 be fixedly embedded in a corresponding first cavity slot 421 without moving arbitrarily when the ultrasonic massage device 1 is placed in the first cavity slot 421, as shown in FIG. 5 and FIG. 7, magnets 7 are provided on each ultrasonic massage device 1 and on the corresponding first cavity slot 421 so that each ultrasonic massage device 1 is attracted to the corresponding first cavity slot 421. Similarly, magnets 7 are also provided on the controller 5 and on the second cavity slot 422 so that the controller 5 is attracted to the second cavity slot 422 to ensure the controller 5 be fixedly embedded in the second cavity slot 422.

A supporting mobile application may also be developed to establish a communication connection between the supporting mobile application and the controller 5 through Bluetooth® modules or WIFI modules, and hence the operation of the invention may be controlled by a smartphone.

What is claimed is:

1. An ultrasonic massage instrument, comprising at least one ultrasonic massage device; two lateral sides of each ultrasonic massage device are respectively provided with a connecting belt and a connecting piece with a through hole; when said at least one ultrasonic massage device comprises only one ultrasonic massage device, a free end of the connecting belt passes through the through hole of the connecting piece and is folded and fixed on the connecting belt, such that a working cavity is formed between the connecting belt and surfaces of the ultrasonic massage device facing to the soft connecting belt.

2. The ultrasonic massage instrument of claim 1, wherein when said at least one ultrasonic massage device comprises a plurality of ultrasonic massage devices, the connecting belt of any one of the ultrasonic massage devices is connected to the connecting piece of another adjacent ultrasonic massage device to form an ultrasonic massage main body in a shape of an annular chain; the working cavity is enclosed by an inner side of the ultrasonic massage main body.

3. The ultrasonic massage instrument of claim 1, wherein an outer protruding part with a slot is provided on each ultrasonic massage device; a lock hole is provided on the outer protruding part; an end of the connecting belt fitted with the outer protruding part is provided with a plug in cooperation with the slot; a snap pin in cooperation with the lock hole is provided on the plug.

4. The ultrasonic massage instrument of claim 2, also comprising a charging storage box, which comprises a cover and a base; the base is provided with at least one first cavity slot where said at least one ultrasonic massage device is stored; a micro storage battery is provided in each ultrasonic massage device; charging interfaces are provided between each first cavity slot and a corresponding ultrasonic massage device.

5. The ultrasonic massage instrument of claim 4, also comprising a controller to operate and control said at least one ultrasonic massage device; the controller has a micro storage battery; the charging storage box is also provided with a second cavity slot to accommodate the controller; charging interfaces are also provided between the second cavity slot and the controller; the controller is connected to said at least one ultrasonic massage device through wireless communication modules.

6. The ultrasonic massage instrument of claim 5, wherein the base comprises a base case, a charging circuit board, a storage battery, and a power interface; the charging circuit board and the storage battery are installed in the base case, and the power interface is installed on a lateral side of the base case.

7. The ultrasonic massage instrument of claim 4, wherein each ultrasonic massage device comprises a case, an ultrasonic vibrating element, a micro storage battery, and a micro working circuit board; one side of the case is provided with a plurality of evenly distributed massage bumps, and another side of the case is provided with a charging interface of the charging interfaces provided between each first cavity slot and the corresponding ultrasonic massage device; the ultrasonic vibrating element, the micro storage battery, and the micro working circuit board are installed in the case.

8. The ultrasonic massage instrument of claim 7, wherein a sealed inner cavity is provided in an interior of the case proximal to the side of the case provided with the massage bumps; gaps are formed between the massage bumps; spray holes in communication with the sealed inner cavity are provided on the gaps; a tube port in communication with the sealed inner cavity is provided on said another side of the case.

9. The ultrasonic massage instrument of claim 7, wherein magnets are provided on each ultrasonic massage device and on the corresponding first cavity slot respectively.

10. The ultrasonic massage instrument of claim 5, wherein magnets are provided on the controller and on the second cavity slot respectively.
